(19) United States
(12) Patent Application Publication
(10) Pub. No.: US 2008/0177548 A1
(43) Pub. Date: Jul. 24, 2008

(54) Speech Synthesis Method and Apparatus

(75) Inventors: Masayuki Yamada, Kanagawa-ken (JP); Yasuo Okutani, Kanagawa-ken (JP); Michio Aizawa, Kanagawa-ken (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/579,864

(22) PCT Filed: May 29, 2006
(86) PCT No.: PCT/JP06/11139

§ 371 Date: Nov. 8, 2006

(30) Foreign Application Priority Data
May 31, 2005 (JP) 2005-159123

(51) Int. Cl. G10L 13/08

(52) U.S. Cl. 704/260; 704/258; 704/E19.001

(57) ABSTRACT

A speech synthesis method includes selecting a segment, determining whether to conduct prosodic modification on the selected segment, calculating a target value of prosodic modification of a segment on which prosodic modification has been determined to be conducted based on a result of the determination, conducting prosodic modification such that a prosody of the segment on which prosodic modification has been determined to be conducted takes the target value of prosodic modification, and concatenating the segment on which prosodic modification has been conducted or a segment on which prosodic modification has been determined not to be conducted as a result of the determination.

### TECHNICAL FIELD

The present invention relates to a speech synthesis method for synthesizing desired speech.

### BACKGROUND ART

A speech synthesis technology for synthesizing desired speech is known. The speech synthesis is realized by concatenating speech segments corresponding to the desired speech content and adjusting them so as to achieve the desired prosody.

One of the typical speech synthesis technologies is based on the speech source-voice tract model. In this model, the speech segment is a vocal tract parameter sequence. Using this vocal tract parameter, a filtering process is conducted on the pulse sequence simulating the vocal cord vibration or the noise simulating the noise caused by exhalation, thus obtaining synthesized speech.

More recently, a speech synthesis technology referred to as the corpus-based speech synthesis has become widely-used (for example, refer to Segi, Takagi, “Segmental Selection from Broadcast News Recordings for a High Quality Concatinative Speech Synthesis”, Technical report of IEICE, SP2003-35, pp. 1-6, June (2003)). In this technology, various variations of speech are pre-recorded, and only the concatenating of the segments is conducted in the synthesis. In a corpus-based speech synthesis, the prosody adjustment is conducted by selecting a segment with the desired prosody from a large number of segments as appropriate.

Generally, in a corpus-based speech synthesis, a natural and high-quality synthesized speech can be obtained, as compared to speech synthesis based on the speech source-vocal tract model. This is said to be due to the corpus-based speech synthesis not including a process for transforming speech, such as modeling or signal processing (which causes degradation of speech).

However, in the case where a segment with the desired prosody is not found in the corpus-based speech synthesis described above, the quality of synthesized speech is degraded. In particular, a prosodic gap is generated between the segment not having the desired prosody and the adjoining segments, thus causing a severe loss of the naturalness in the synthesized speech.

### DISCLOSURE OF INVENTION

According to an aspect of the present invention, there is provided a speech synthesis method including selecting a segment, determining whether to conduct prosodic modification on the selected segment, calculating a target value of prosodic modification of a segment on which prosodic modification has been determined to be conducted, conducting prosodic modification such that a prosody of the segment on which prosodic modification has been determined to be conducted takes the calculated target value of prosodic modification, and concatenating the segment on which prosodic modification has been conducted or a segment on which prosodic modification has been determined not to be conducted.

According to another aspect of the present invention, there is provided a speech synthesis apparatus including a selecting unit configured to select a segment, a determining unit configured to determine whether to conduct prosodic modification on the selected segment, a calculating unit configured to calculate a target value of prosodic modification of a segment on which prosodic modification has been determined to be conducted based on a determination result by the determining unit, a modification unit configured to conduct prosodic modification such that a prosody of the segment on which prosodic modification has been determined to be conducted takes the calculated target value of prosodic modification, and a segment concatenating unit configured to concatenate the segment on which prosodic modification has been conducted or a segment on which prosodic modification has been determined not to be conducted based on a determination result by the determining unit.

Further features of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments of the invention and, together with the description, serve to explain the principles of the invention.

FIG. 1 is a block diagram illustrating a hardware configuration of a speech synthesis apparatus according to an exemplary embodiment of the present invention.

FIG. 2 is a flowchart of the process flow according to a first exemplary embodiment.

FIG. 3 is a flowchart of the process flow according to a second exemplary embodiment.

FIG. 4 is a flowchart of the process flow according to a third exemplary embodiment.

### BEST MODE FOR CARRYING OUT THE INVENTION

Exemplary embodiments of the invention will be described in detail below with reference to the drawings.

### First Exemplary Embodiment

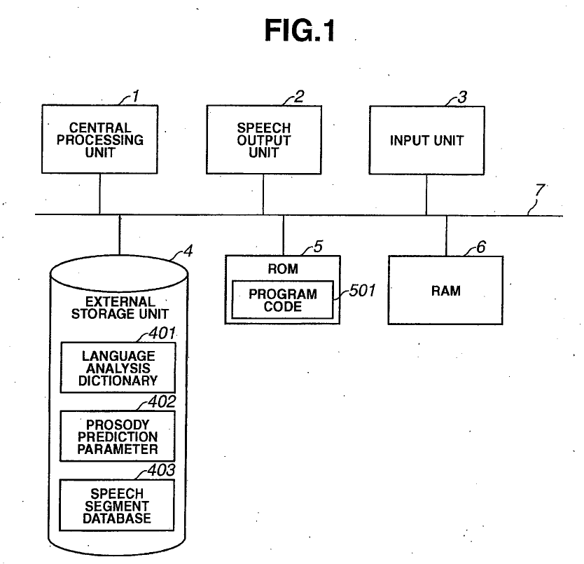

FIG. 1 illustrates a hardware configuration of a speech synthesis apparatus according to a first exemplary embodiment of the present invention. A central processing unit 1 conducts processing such as numerical processing and control, and conducts the numerical processing according to the procedure of the present invention. A speech output unit 2 outputs speech. An input unit 3 includes, for example, a touch panel, a keyboard, a mouse, a button, or some combination thereof, and is used by a user to instruct an operation to be conducted by the apparatus. The input unit 3 may be omitted in the case where the apparatus operates autonomously without any instruction from the user.

An external storage unit 4 includes a disk or a nonvolatile memory which stores a language analysis dictionary 401, a prosody prediction parameter 402, and a speech segment database 403. In addition, the external storage unit 4 stores information that should be used permanently among various information stored in the RAM 6. Furthermore, the external storage unit 4 may take a transportable form such as a CD-ROM or a memory card, which can increase the convenience.

A read-only memory (ROM) 5 stores program code 501 for implementing the present invention, fixed data (not shown), and so on. The use of the external storage unit 4 and the ROM 5 is arbitrary in the present invention. For example, the program code 501 may be installed on the external storage unit 4 instead of the ROM 5. A memory 6, such as a random access memory (RAM), stores temporary information, temporary data, and various flags. The above-described units 1 to 6 are connected with one another via a bus 7.

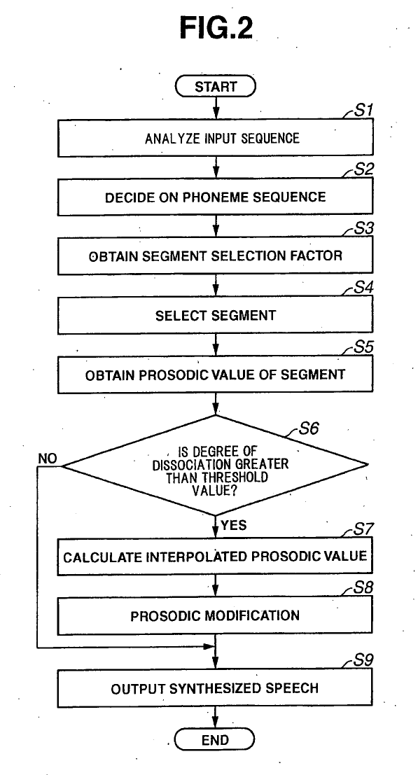

The process flow in the first exemplary embodiment is described next with reference to FIG. 2. In step S1, an input speech synthesis target (input sequence) is analyzed. In the case where the speech synthesis target is a natural language such as “Kyou-wa yoi tenki-desu,” in Japanese, a natural language processing method such as morphological analysis or syntax analysis (parsing) is used in this step. The language analysis dictionary 401 is used accordingly in conducting the analysis. On the other hand, in the case where the speech synthesis target is written in an artificial language for speech synthesis, such as “KYO'OWA/YO'I/TE'NKIDESU” in Japanese, an exclusive analyzing process is used in this step.

In step S2, a phoneme sequence is decided based on a result of the analysis in step S1. In step S3, a factor for selecting segments is obtained based on the result of the analysis in step S1. The factor for selecting segments includes, for example, the number of moras or the accent type of the phrase to which each phoneme belongs, the position within the sentence, phrase, or word, and the phoneme type. In step S4, the appropriate segment is selected from the speech segment database 403 stored in the external storage unit 4, based on the result of step S3. Besides using the result of step 3 as the information for selecting segments, the selection can be made so that the gap in the spectral shape or the prosody between the adjoining segments is kept small.

In step S5, the prosodic value of the segment selected in step 4 is obtained. The prosodic value of a segment can be measured directly from the selected segment, or a value measured in advance and stored in the external storage unit 4 can be read out to be used as the prosodic value of a segment. Generally, prosody often refers to fundamental frequency (F0), duration, and power. The present process may be conducted by obtaining only a part of the prosodic information since prosodic modification is basically not conducted in a corpus-based speech synthesis, and it is not necessary to obtain information that is not subjected to prosodic modification.

In step S6, the degree of dissociation of the prosodic value of the segment obtained in step S5 from that of the adjoining segment is evaluated. In the case where the degree of dissociation is greater than a threshold value, the process proceeds to step S7. In the case where the degree of dissociation is not greater than the threshold value, the process proceeds to step S9.

In the case where the prosody is F0, a plurality of values correspond to one segment. Therefore, a plurality of methods can be considered in evaluating the degree of dissociation. For example, a representative value such as the average value, the intermediate value, the maximum value, or the minimum value of F0, F0 at the center of the segment, or F0 at the end-point of the segment may be used. Furthermore, the slope of F0 may be used.

In step S7, the prosodic value after conducting prosodic modification is calculated. In the simplest terms, a constant number is added or multiplied to the prosodic value of the segment obtained in step S5 so that the degree of dissociation used in step S6 becomes minimum. Alternatively, it is possible to keep the amount of prosodic modification so that the degree of dissociation in step S6 falls within the range of the threshold value. Furthermore, the prosodic value of the segment which has been determined not to be modified in step S6 can be interpolated so as to be used as the prosodic value after conducting prosodic modification.

In step S8, the prosodic value of the segment is modified based on the prosodic value calculated in step S7. Various methods used in conventional speech synthesis (for example, the PSOLA (pitch synchronous overlap add) method) can be used to modify the prosody.

In step S9, based on the result of step 6, either the segments selected in step S4 or the segments in which the prosody is modified in step S8 are concatenated and output as a synthesized speech.

According to the above exemplary embodiment, even in the case where a segment with the desired prosody is not found, the prosodic gap between the segment not having a desired prosody and the adjoining segment is reduced. As a result, the quality of the synthesized speech is prevented from being greatly degraded.

### Second Exemplary Embodiment

According to a second exemplary embodiment, a method is performed in which prosody prediction is conducted based on the result of a language analysis and the predicted prosody is used.

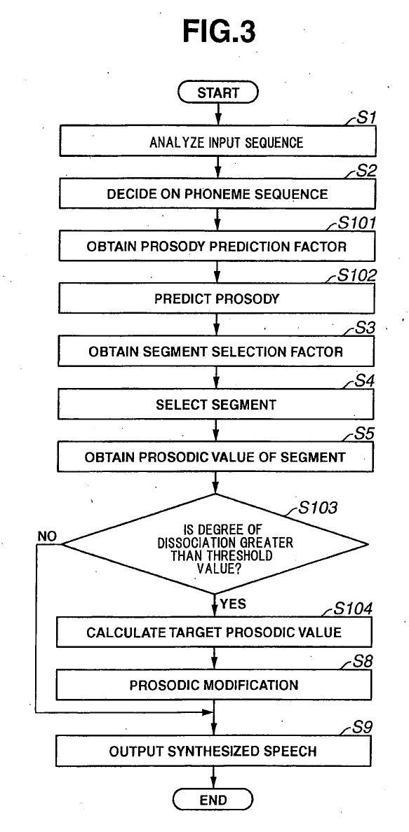

The process flow of the second exemplary embodiment is described with reference to FIG. 3. The processes in steps S1 and S2 are similar to those in the first exemplary embodiment. In step S101, a factor for predicting the prosody is obtained based on the result of the analysis in step S1. The factor for predicting the prosody includes, for example, the number of moras or the accent type of the phrase to which each phoneme belongs, the position within the sentence, phrase, or word, the phoneme type, or information on the adjoining phrase or word.

In step S102, the prosody is predicted based on the prosody prediction factor obtained in step S101 and the prosody prediction parameter 402 stored in the external storage unit 4. Generally, prosody often refers to fundamental frequency (F0), duration, and power. The present process may be conducted by obtaining only a part of the prosodic information since the prosodic value of the segment can be used in conducting a corpus-based speech synthesis, and it is not necessary to predict all of the prosodic information.

Next, the processes of obtaining the segment selection factor (step S3), selecting the segment (step S4), and obtaining the prosodic value of the segment (step S5) are conducted as in the first exemplary embodiment. Since prosody prediction is conducted in the present exemplary embodiment, the prosody predicted in step S102 may be used as information for selecting the segment.

In step S103, the degree of dissociation of the prosodic value predicted in step S102 from the segment obtained in step S5 is evaluated. In the case where the degree of dissociation is greater than a threshold value, the process proceeds to step S104. In the case where the degree of dissociation is not greater than the threshold value, the process proceeds to step S9.

In the case where the prosody is F0, a plurality of values corresponds to one segment. Consequently, various methods of evaluating the degree of dissociation can be considered. For example, a representative value such as the average value, the intermediate value, the maximum value, and the minimum value of F0, F0 at the center of the segment, or a mean square error between the predicted prosodic value and the prosodic value of the segment can be used.

In step S104, the prosodic value after modifying the prosody is calculated. In the simplest terms, the prosodic value after conducting prosodic modification can be calculated so as to become equal to the prosodic value predicted in step S102. Alternatively, the amount of prosodic modification can be kept so that the degree of dissociation in step S103 falls within the range of the threshold value. Steps S8 and S9 are similar to those in the first exemplary embodiment.

### Third Exemplary Embodiment

According to a third exemplary embodiment, the segment is re-selected in the case of the segment on which prosodic modification has been determined to be conducted in the above-described exemplary embodiment.

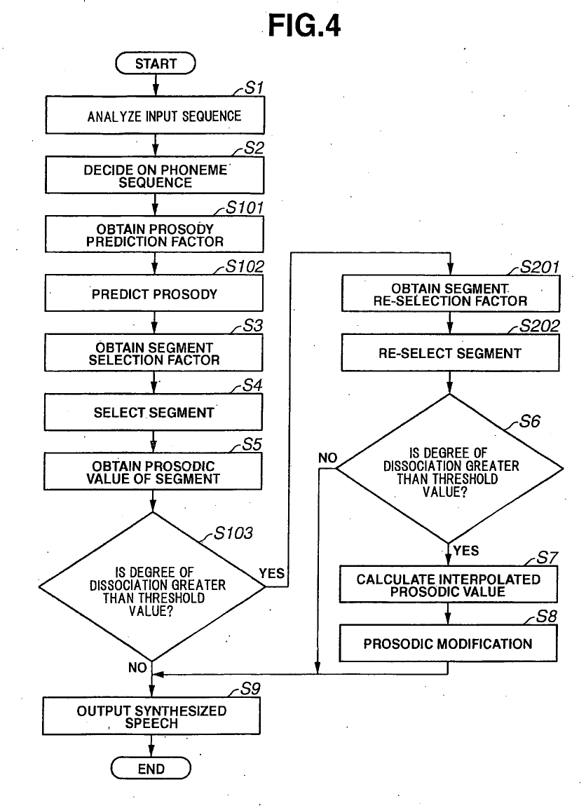

The process flow of the third exemplary embodiment is described with reference to FIG. 4. The processes in steps S1 to S5 are similar to those in the second exemplary embodiment. In step S103, a determination similar to that in the second exemplary embodiment is made. In the case where the degree of dissociation is greater than the threshold value, the process proceeds to step S201. In the case where the degree of dissociation is not greater than the threshold value, the process proceeds to step S9.

In step S201, a factor for re-selecting the segment is obtained. In addition to the factor used in step S3, information on the segment on which prosodic modification has been determined not to be conducted can be used as a factor for re-selecting the segment. For example, the consecutiveness of the prosody can be improved by using the prosodic value of the segment on which prosodic modification has been determined not to be conducted in step S103. Alternatively, the spectral consecutiveness of the segment to be re-selected and the segment obtained in step S5 can be considered.

In step S202, as in step S4, the segment is selected based on the result of step S201.

Furthermore, as in the first exemplary embodiment, in the case where the degree of dissociation of the prosodic values between the adjoining segments is greater than a threshold value, prosodic modification is conducted (steps S6, S7, and S8). Finally, a synthesized speech is output as in the above-described exemplary embodiment (step S9).

According to the third exemplary embodiment, a more appropriate segment can be selected.

The present invention can also be achieved by supplying a storage medium storing program code (software) which realizes the functions of the above-described exemplary embodiments to a system or an apparatus, and causing a computer (or CPU or micro-processing unit (MPU)) of the system or the apparatus to read and execute the program code stored in the storage medium.

In this case, the program code itself that is read from the storage medium realizes the function of the above-described exemplary embodiments.

The storage medium for supplying the program code includes, for example, a flexible disk, a hard disk, an optical disk, a magneto-optical disk, a compact disk-ROM (CD-ROM), a CD-recordable (CD-R), a magnetic tape, a nonvolatile memory card, and a ROM.

Furthermore, in addition to realizing the functions of the above-described exemplary embodiments by executing the program code read by a computer, the present invention includes also a case in which an operating system (OS) running on the computer performs a part or the whole of the actual process according to instructions of the program code, and that process realizes the functions of the above-described exemplary embodiments.

Furthermore, the present invention also includes a case in which, after the program code is read from the storage medium and written into a memory of a function expansion board inserted in the computer or a function expansion unit connected to the computer, a CPU in the function expansion board or the function expansion unit performs a part of or the whole process according to instructions of the program code and that process realizes the functions of the above-described exemplary embodiments.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2005-159123 filed May 31, 2005, which is hereby incorporated by reference herein in its entirety.

1. A speech synthesis method comprising:
selecting a segment;
determining whether to conduct prosodic modification on the selected segment;
calculating a target value of prosodic modification of the selected segment when it is determined that prosodic modification is to be conducted on the selected segment;
conducting prosodic modification such that a prosody of the selected segment on which prosodic modification has been determined to be conducted takes the calculated target value of prosodic modification; and
concatenating the selected segment on which prosodic modification has been conducted or the selected segment on which prosodic modification has been determined not to be conducted.

2. A speech synthesis method as claimed in claim 1, wherein determining whether to conduct prosodic modification on the selected segment includes determining whether to conduct prosodic modification based on a degree of dissociation of prosody from that of an adjoining segment.

3. A speech synthesis method as claimed in claim 1, wherein calculating the target value of prosodic modification of the selected segment includes calculating the target value of prosodic modification based on a prosodic value of the segment on which prosodic modification has been determined not to be conducted.

4. A speech synthesis method as claimed in claim 1, further comprising predicting a prosody, wherein determining whether to conduct prosodic modification on the selected segment includes determining whether to conduct prosodic modification based on a degree of dissociation from the predicted prosody.

5. A speech synthesis method as claimed in claim 1, further comprising predicting a prosody, wherein calculating the target value of prosodic modification of the selected segment includes calculating the target value of prosodic modification based on the predicted prosody.

6. A speech synthesis method as claimed in claim 1, further comprising re-selecting a segment for a segment on which prosodic modification has been determined to be conducted.

7. A speech synthesis method as claimed in claim 6, wherein re-selecting the segment includes re-selecting the segment based on information on the segment on which prosodic modification has been determined not to be conducted.

8. A speech synthesis method as claimed in claim 6, further comprising re-determining whether to conduct prosodic modification on the re-selected segment, wherein prosodic modification is conducted on a segment oh which prosodic modification has been re-determined to be conducted.

9. A control program for causing a computer to execute the speech synthesis method as claimed in claim 1.

10. A speech synthesis apparatus comprising:
a selecting unit configured to select a segment;
a determining unit configured to determine whether to conduct prosodic modification on the selected segment;
a calculating unit configured to calculate a target value of prosodic modification of a segment on which prosodic modification has been determined to be conducted based on a determination result by the determining unit;
a modification unit configured to conduct prosodic modification such that a prosody of the segment on which prosodic modification has been determined to be conducted takes the calculated target value of prosodic modification; and
a segment concatenating unit configured to concatenate the segment on which prosodic modification has been conducted or a segment on which prosodic modification has been determined not to be conducted based on a determination result by the determining unit.
